(19) United States
(12) Patent Application Publication
(10) Pub. No.: US 2021/0198507 A1
(43) Pub. Date: Jul. 1, 2021

(54) Ink Jet Ink And Recording Apparatus

(71) Applicant: Seiko Epson Corporation, Tokyo (JP)

(72) Inventors: Hiroaki KUMETA, Matsumoto (JP); Soichi YAMAZAKI, Shiojiri (JP); Manabu TANIGUCHI, Shiojiri (JP); Shunsuke UCHIZONO, Shiojiri (JP); Miki IINUMA, Shiojiri (JP); Sena GOZU, Shiojiri (JP)

(21) Appl. No.: 17/132,382

(22) Filed: Dec. 23, 2020

(30) Foreign Application Priority Data
Dec. 26, 2019 (JP) 2019-236132

(51) Int. Cl. C09D 11/324; C09D 11/38; C08K 3/36; C08K 5/17; B41J 2/21; B41J 2/14

(52) U.S. Cl. CPC C09D 11/324; C09D 11/38; C08K 3/36; C08L 25/14; B41J 2/2107; B41J 2/14; C08K 5/175

(57) ABSTRACT

An ink jet ink contains a pigment; an inorganic oxide colloid; a betaine; and water, and in the ink jet ink described above, a total concentration (mg/L) of potassium ions and sodium ions in the ink is 500 ppm or less.

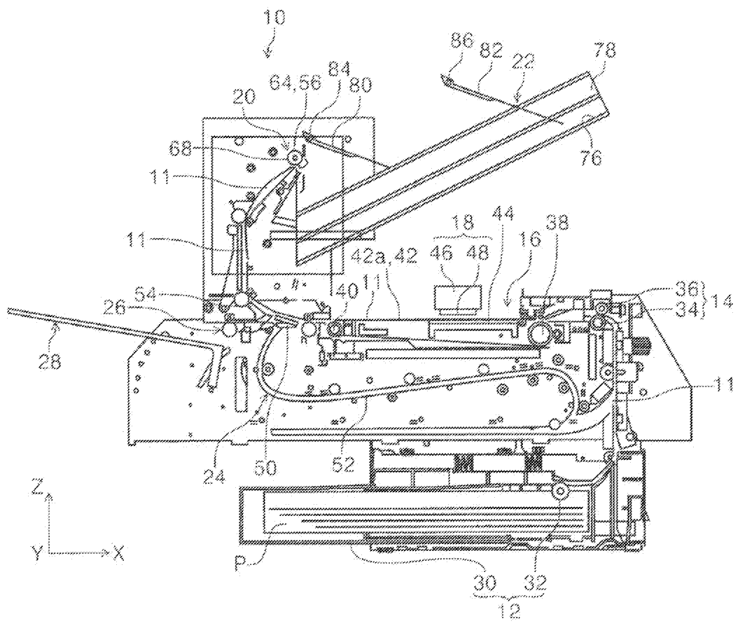

The present application is based on, and claims priority from JP Application Serial Number 2019-236132, filed Dec. 26, 2019, the disclosure of which is hereby incorporated by reference herein in its entirety.

### BACKGROUND

### 1. Technical Field

The present disclosure relates to an ink jet ink and a recording apparatus.

### 2. Related Art

An ink jet recording method is able to record a highly fine image by a relatively simple apparatus and has been rapidly developed in various fields. Among the developments, various investigations on image quality and the like have been carried out. For example, in order to improve an effect of preventing strike through, a character quality, and a surface reflection density, JP-A-2006-321876 has disclosed an aqueous ink using an inorganic oxide colloid.

However, when an ink containing an inorganic oxide colloid is used as disclosed in JP-A-2006-321876, if a nozzle is clogged once, a problem may occur in some cases such that the clogging of the nozzle is not likely to be recovered even by performing a head cleaning operation.

### SUMMARY

According to an aspect of the present disclosure, there is provided an ink jet ink containing: a pigment; an inorganic oxide colloid; a betaine; and water, and in the ink jet ink described above, a total concentration (mg/L) of potassium ions and sodium ions in the ink is 500 ppm or less.

The ink jet ink described above may further contain a resin emulsion.

In the ink jet ink described above, the inorganic oxide colloid may include a colloidal silica.

In the ink jet ink described above, a content of the inorganic oxide colloid as a solid component may be 1.0 to 10 percent by mass with respect to a total mass of the ink.

In the ink jet ink described above, the betaine may include trimethyl glycine.

In the ink jet ink described above, a content of the betaine may be larger than the content of the solid component of the inorganic oxide colloid on a mass basis.

In the ink jet ink described above, a content of the water with respect to the total mass of the ink may be 50 to 80 percent by mass.

In addition, according to another aspect of the present disclosure, there is provided a recording apparatus comprising: an ink jet head having a nozzle which ejects the ink jet ink described above to a recording medium; and a transport device which transports the recording medium.

In the recording apparatus described above, the ink jet head may include a line head.

### BRIEF DESCRIPTION OF THE DRAWING

FIGURE is a schematic cross-sectional view showing a recording apparatus according to this embodiment.

### DESCRIPTION OF EXEMPLARY EMBODIMENTS

Hereinafter, if needed, with reference to the drawing, although an embodiment (hereinafter, referred to as “this embodiment”) of the present disclosure will be described in detail, the present disclosure is not limited thereto and may be variously changed and/or modified without departing from the scope of the present disclosure. In addition, in the drawing, the same element is to be designated by the same reference numeral, and duplicated description will be omitted. In addition, unless otherwise particularly noted, a positional relationship, such as top-to-bottom or left-to-right, is based on a positional relationship shown in the drawing. Furthermore, a dimensional ratio in the drawing is not limited to the ratio shown in the drawing.

### 1. Ink Jet Ink

An ink jet ink (hereinafter, simply referred to as “ink” in some cases) of this embodiment contains a pigment; an inorganic oxide colloid; a betaine; and water, and a total concentration (mg/L) of potassium ions and sodium ions in the ink is controlled to 500 ppm or less.

When an ink containing an inorganic oxide colloid is used, a pigment is likely to stay on a recording medium by a filling effect of the inorganic oxide colloid, and hence, a color developing property of a recorded matter to be obtained is advantageously further improved. However, for example, when a recording apparatus is not used for a long time, the ink is dried in the vicinity of a nozzle, and the inorganic oxide colloid is precipitated in the form of an aggregate, so that nozzle clogging is generated. Since the aggregate is tightly fixed to the nozzle, the clogging as described above is difficult to remove even by cleaning, and as a result, permanent nozzle missing may disadvantageously occur in some cases.

On the other hand, in the ink jet ink described in this embodiment, since the betaine is used, and the total concentration of potassium ions and sodium ions in the ink is controlled, a clogging recovery property of the ink jet ink containing an inorganic oxide colloid can be improved. In addition, although not being clearly understood, the reason the clogging recovery property is improved by using a solvent having the composition as described above has been believed as follows. That is, when the inorganic oxide colloid is aggregated by drying, the betaine functions as a protective colloid and prevents the formation of a hard aggregate, and in addition, since the total concentration of potassium ions and sodium ions in the ink is controlled, a dispersion stability of the inorganic oxide colloid is improved.

Hereinafter, the components of the ink jet ink according to this embodiment, physical properties of the components, and a manufacturing method of the ink jet ink will be described.

### 1.1. Pigment

Although the pigment is not particularly limited, for example, there may be mentioned an azo pigment (such as an azo lake, an insoluble azo pigment, a condensed azo pigment, or a chelate azo pigment); a polycyclic pigment (such as a phthalocyanine pigment, a perylene pigment, a perynone pigment, an anthraquinone pigment, a quinacridone pigment, a dioxazine pigment, a thioindigo pigment, an isoindolinone pigment, or a quinophthalone pigment); an organic pigment, such as a nitro pigment, a nitroso pigment, or an aniline black; a carbon black (such as a furnace black, a thermal lamp black, an acetylene black, or a channel black); an inorganic pigment, such as a metal oxide, a metal sulfide, or a metal chloride; or an extender pigment, such as calcium carbonate or a talc.

The pigment described above is preferably added to the ink in the form of a pigment dispersion liquid which is selected from the group consisting of a pigment dispersion liquid formed by dispersing a pigment in water with a dispersant; a pigment dispersion liquid formed by dispersing a self-dispersible surface-treated pigment in water, the self-dispersible surface-treated pigment being formed by introducing hydrophilic groups on pigment particle surfaces using a chemical reaction; and a pigment dispersion liquid formed by dispersing a pigment covered with a polymer in water.

The pigment and the dispersant which form the pigment dispersion liquid described above each may be used alone, or at least two types thereof may be used in combination.

The content of the pigment as a solid component with respect to the total mass of the ink is preferably 1.0 to 12 percent by mass, more preferably 2.0 to 10 percent by mass, and further preferably 3.0 to 9.0 percent by mass.

### 1.2. Inorganic Oxide Colloid

The inorganic oxide colloid indicates a state in which particles, such as SiO₂ or Al₂O₃, are dispersed in a dispersion medium, and in this embodiment, the “ink containing an inorganic oxide colloid” indicates a state in which inorganic oxide particles are dispersed using a solvent which forms an ink as a dispersion medium.

Although the inorganic oxide colloid is not particularly limited, for example, a colloidal silica or an alumina colloid may be mentioned. Among those mentioned above, a colloidal silica is preferable. By using the inorganic oxide colloid as described above, the color developing property of the recorded matter to be obtained is further improved, and curling and/or cockling is further suppressed, so that a high speed transport of a recording medium can be performed. In addition, compared to a dry silica, such as a fumed silica, according to a colloidal silica, the precipitation is suppressed, and the dispersion stability tends to be further improved, and even when a colloidal silica is contained, since the viscosity of the ink jet ink is not likely to be increased, the ejection stability also tends to be improved. In addition, since the inorganic oxide colloid as described above is used, and the total concentration of potassium ions and sodium ions in the ink is controlled, the clogging recovery property tends to be further improved. In addition, the inorganic oxide colloid may be used alone, or at least two types thereof may be used in combination.

The particles of the inorganic oxide colloid may be surface-treated particles. For example, the colloidal silica may be surface-treated with alumina. Accordingly, a pH range in which the colloid can be stably dispersed is increased, and the dispersion stability tends to be further improved.

As the colloidal silica described above, a commercially available product may also be used, and for example, Snowtex 20, Snowtex 30, Snowtex 40, Snowtex 0, Snowtex N, or Snowtex C (each manufactured by Nissan Chemical Corporation) may be mentioned.

An average particle diameter of the inorganic oxide colloid is preferably 5 to 150 nm, more preferably 5 to 100 nm, and further preferably 10 to 70 nm. Since the average particle diameter is 150 nm or less, the precipitation is suppressed, and the dispersion stability tends to be further improved. Since the average particle diameter of the inorganic oxide colloid is 5 nm or more, a sliding friction of a printing surface tends to be further improved.

The average particle diameter of the colloidal silica may be measured by a particle size distribution measurement device using a dynamic light scattering method as a measurement principle. As the particle size distribution measurement device described above, for example, there may be mentioned a “Zeta-potential/Particle size/Molecular weight Measurement System ELSZ2000ZS” (trade name) which is manufactured by Otsuka Electronics Co., Ltd. and which uses a homodyne optical system as a frequency analysis method. In addition, in this specification, unless otherwise particularly noted, the “average particle diameter” indicates a number-basis average particle diameter.

The content of the inorganic oxide colloid as a solid component with respect to the total mass of the ink is preferably 0.5 to 15 percent by mass, more preferably 1.0 to 10 percent by mass, further preferably 3.0 to 10 percent by mass, and particularly preferably 5.0 to 8.0 percent by mass. Since the content of the inorganic oxide colloid is 0.5 percent by mass or more, the color developing property of the recorded matter to be obtained is further improved, and curling and/or cockling is further suppressed, so that a transport speed of the recording medium can be further improved. In addition, since the content of the inorganic oxide colloid is 15 percent by mass or less, the clogging recovery property tends to be further improved.

### 1.3. Betaine

The betaine according to this embodiment indicates a compound which has a positive charge and a negative charge at positions not adjacent to each other in the same molecule and which has no charge as a whole molecule. A positive charge portion is preferably a quaternary ammonium cation. Although the betaine as described above is not particularly limited, for example, there may be mentioned trimethyl glycine, γ-butyrobetaine, homarine, trigonelline, carnitine, homoserine betaine, valine betaine, lysine betaine, ornithine betaine, alanine betaine, stachydrine, or betaine glutamate. Among those mentioned above, trimethyl glycine, γ-butyrobetaine, or carnitine is preferable, and trimethyl glycine is more preferable. When the betaine as described above is used, the clogging recovery property tends to be further improved. In addition, the betaine may be used alone, or at least two types thereof may be used in combination.

The number of carbon atoms forming the betaine is preferably 4 to 12, more preferably 4 to 7, and further preferably 4 to 6. Since the number of carbon atoms of the betaine is in the range described above, the stability against disturbance, such as intrusion of charged foreign materials, tends to be further improved.

The content of the betaine with respect to the total mass of the ink is preferably 1 to 30 percent by mass, more preferably 3 to 20 percent by mass, and further preferably 4 to 16 percent by mass. Since the content of the betaine is in the range described above, when the inorganic oxide colloid is aggregated by drying, a hard aggregate is suppressed from being formed, and in addition, since the dispersion stability of the inorganic oxide colloid is improved, the clogging recovery property tends to be further improved.

The content of the betaine is preferably larger than the content of the solid component of the inorganic oxide colloid on a mass basis. In particular, the content of the betaine with respect to the content of the solid component of the inorganic oxide colloid is, on a mass basis, preferably 1.1 to 10 times, more preferably 1.1 to 8.0 times, and further preferably 1.1 to 5.0 times. Since the content of the betaine is in the range described above, the clogging recovery property tends to be further improved.

### 1.4. Water

The content of the water with respect to the total mass of the ink is preferably 40 to 80 percent by mass, more preferably 50 to 80 percent by mass, even more preferably 55 to 75 percent by mass, and further preferably 55 to 70 percent by mass. Since the content of the water is 40 percent by mass or more, even when the water is partially evaporated, an increase in viscosity of the ink is suppressed, and the ejection stability tends to be further improved. In addition, since the content of the water is 80 percent by mass or less, curling and/or cockling of the recorded matter to be obtained tends to be further suppressed.

### 1.5. Potassium Ions and Sodium Ions

The total concentration (mg/L) of potassium ions and sodium ions in the ink of this embodiment is 500 ppm or less, preferably 400 ppm or less, more preferably 350 ppm or less, and further preferably 300 ppm or less. A lower limit of the total concentration (mg/L) of potassium ions and sodium ions in the ink is preferably 50 ppm or more, more preferably 100 ppm or more, and further preferably 150 ppm or more. Since the total concentration of potassium ions and sodium ions in the ink is 500 ppm or less, an electrostatic repulsion force of the inorganic oxide colloid, particles of which are primarily negatively charged and are dispersed by the electrostatic repulsion force, is maintained, and hence, the dispersion stability is further improved.

Although cations are believed to contribute to the dispersion stability and aggregation property of the inorganic oxide colloid, influences on the dispersion stability and aggregation property are different from each other among various types of cations. For example, an influence of an organic alkali, such as triethanolamine, on the dispersion stability and aggregating property is lower than that of an alkali metal ion, and in addition, although a lithium ion among metal ions is a monovalent metal ion similar to a potassium ion or a sodium ion, the influence thereof on the dispersion stability and aggregating property is low. Hence, in this embodiment, the total concentration of potassium ions and sodium ions is defined.

In addition, the concentration of divalent metal ions contained in the ink of this embodiment is preferably low. In more particular, the concentration (mg/L) of divalent metal ions is preferably 20 ppm or less and more preferably 10 ppm or less. In addition, a lower concentration of divalent metal ions is more preferable, and although a lower limit thereof is not particularly limited, for example, the lower limit may be set to a detectable level or less. Since the concentration of divalent metal ions in the ink is 20 ppm or less, the electrostatic repulsion force of the inorganic oxide colloid, the particles of which are primarily negatively charged and are dispersed by the electrostatic repulsion force, is maintained, and the dispersion stability tends to be further improved. In this embodiment, although the divalent metal ions are not particularly limited, for example, calcium ions may be mentioned.

The potassium ions and sodium ions are arbitrarily added in the ink, for example, as a pH adjuster which will be described below and, in addition, may also be mixed in the ink together with the pigment and the inorganic oxide colloid. The amounts of potassium ions and sodium ions to be mixed in the ink may be changed dependent on the types of pigments and inorganic oxide colloids and on the addition amounts thereof. Hence, in order to finally control the total concentration of potassium ions and sodium ions in the ink to 500 ppm or less, the control can be performed by a pH adjuster and/or an ion removal using a dialysis membrane.

### 1.6. Resin Emulsion

The ink jet ink of this embodiment may further contain a resin emulsion. Although the resin emulsion is not particularly limited, for example, an urethane resin emulsion or a (meth)acrylic resin emulsion may be mentioned. Since the resin emulsion as described above is used, blurring of an image to be obtained is further suppressed, and an abrasion resistance also tends to be further improved. The resin emulsion may be used alone, or at least two types thereof may be used in combination.

The urethane resin emulsion is not particularly limited as long as having an urethane bond in its molecule, and for example, a polyether urethane resin having an ether bond in its main chain, a polyester urethane resin having an ester bond in its main chain, or a polycarbonate urethane resin having a carbonate bond in its main chain may be mentioned. Among those mentioned above, anionic urethane resin particles are preferable.

Although the acrylic resin emulsion is not particularly limited, for example, there may be mentioned a resin obtained by polymerization of a (meth)acrylic monomer, such as (meth)acrylic acid or a (meth)acrylic acid ester or a resin, such as a styrene-acrylic resin, obtained by copolymerization between a (meth)acrylic monomer and another monomer. Among those mentioned above, anionic acrylic resin particles are preferable.

A glass transition temperature (Tg) of the resin emulsion is preferably 25° C. or less, more preferably 10° C. or less, and further preferably −5° C. or less. A lower limit of the glass transition temperatures of the resin emulsion is preferably −40° C. or more, more preferably −30° C. or more, and further preferably −20° C. or more. Since the glass transition temperature of the resin emulsion is 25° C. or less, film formation can be performed at a lower temperature, and a fixing property of the recorded matter to be obtained tends to be improved. In addition, since the glass transition temperature of the resin emulsion is −40° C. or more, the abrasion resistance of the recorded matter to be obtained tends to be further improved.

The content of the resin emulsion with respect to the total mass of the ink is preferably 0.1 to 7.5 percent by mass, more preferably 0.3 to 5.0 percent by mass, and further preferably 0.5 to 3.0 percent by mass. Since the content of the resin emulsion is 0.1 percent by mass or more, blurring of the image to be obtained is suppressed, and the abrasion resistance also tends to be further improved. In addition, since the content of the resin emulsion is 7.5 percent by mass or less, the ejection stability tends to be further improved.

### 1.7. Water-Soluble Organic Solvent

The ink jet ink of this embodiment may contain, besides the components described above, a water-soluble organic solvent. Although the water-soluble organic solvent is not particularly limited, for example, there may be mentioned glycerin; a nitrogen-containing solvent, such as 2-pyrrolidone or N-methylpyrrolidone; a glycol, such as ethylene glycol, diethylene glycol, triethylene glycol, propylene glycol, dipropylene glycol, tripropylene glycol, propanediol, butanediol, pentanediol, or hexylene glycol; or a glycol monoalkyl ether, such as ethylene glycol monomethyl ether, diethylene glycol monomethyl ether, diethylene glycol monoethyl ether, or diethylene glycol monobutyl ether. Among those mentioned above, in view of a moisturizing effect, glycerin is preferable.

The content of the water-soluble organic solvent with respect to the total mass of the ink is preferably 0.5 to 25 percent by mass, more preferably 3.0 to 20 percent by mass, and further preferably 5.0 to 15 percent by mass.

### 1.8. Surfactant

The ink jet ink of this embodiment may contain a surfactant. Although the surfactant is not particularly limited, for example, there may be mentioned an acetylene glycol surfactant, a fluorine surfactant, or a silicone surfactant. Among those mentioned above, in view of the clogging recovery property, an acetylene glycol surfactant is preferable.

Although the acetylene glycol surfactant is not particularly limited, for example, at least one selected from the group consisting of 2,4,7,9-tetramethyl-5-decyne-4,7-diol, an alkylene oxide adduct thereof, 2,4-dimethyl-5-decyne-4-ol, and an alkylene oxide adduct thereof is preferable. Although a commercially available product of the acetylene glycol surfactant is not particularly limited, for example, there may be mentioned an Olfine 104 series or an E series such as Olfine E1010 (product name, manufactured by Air Products and Chemicals Inc.), or Surfynol 61, 104, or 465 (product name, manufactured by Nisshin Chemical Industry Co., Ltd.). The acetylene glycol surfactant may be used alone, or at least two types thereof may be used in combination.

Although the fluorine surfactant is not particularly limited, for example, there may be mentioned a perfluoroalkyl sulfonate salt, a perfluoroalkyl carboxylate salt, a perfluoroalkyl phosphate ester, a perfluoroalkyl ethylene oxide adduct, a perfluoroalkyl betaine, or a perfluoroalkylamine oxide compound. Although a commercially available product of the fluorine surfactant is not particularly limited, for example, there may be mentioned 5-144 or S-145 (manufactured by Asahi Glass Co., Ltd.); FC-170C, FC-430, or Fluorad FC4430 (manufactured by Sumitomo 3M Limited); FSO, FSO-100, FSN, FSN-100, or FS-300 (manufactured by Du Pont); or FT-250 or 251 (manufactured by Neos Co., Ltd.). The fluorine surfactant may be used alone, or at least two types thereof may be used in combination.

As the silicone surfactant, for example, there may be mentioned a polysiloxane compound or a polyether-modified organosiloxane. Although a commercially available product of the silicone surfactant is not specifically limited, in particular, for example, there may be mentioned BYK-306, BYK-307, BYK-333, BYK-341, BYK-345, BYK-346, BYK-347, BYK-348, or BYK-349 (trade name, manufactured by BYK Japan KK), or KF-351A, KF-352A, KF-353, KF-354L, KF-355A, KF-615A, KF-945, KF-640, KF-642, KF-643, KF-6020, X-22-4515, KF-6011, KF-6012, KF-6015, or KF-6017 (trade name, manufactured by Shin-Etsu Chemical Co., Ltd.).

The content of the surfactant with respect to the total mass of the ink is preferably 0.1 to 5.0 percent by mass and more preferably 0.1 to 3.0 percent by mass. Since the content of the surfactant is in the range described above, the clogging recovery property tends to be further improved.

### 1.9. pH Adjuster

The ink jet ink of this embodiment may contain, besides the components described above, a pH adjuster. Although the pH adjuster is not particularly limited, for example, there may be mentioned an inorganic acid (such as sulfuric acid, hydrochloric acid, or nitric acid), an inorganic base (such as lithium hydroxide, sodium hydroxide, potassium hydroxide, or ammonia), an organic base (such as triethanolamine, diethanolamine, monoethanolamine, or tripropanolamine), an organic acid (such as adipic acid, citric acid, or succinic acid). Among those mentioned above, an organic base is preferable. The pH adjuster may be used alone, or at least two types thereof may be used in combination.

The pH of the ink of this embodiment is preferably 6 to 10. Since the pH is in the range described above, the clogging recovery property tends to be further improved. Although the content of the pH adjuster is not particularly limited as long as the pH can be controlled in a target range, for example, the content of the pH adjuster with respect to the total mass of the ink is preferably 0.1 to 5.0 percent by mass and more preferably 0.1 to 3.0 percent by mass.

### 1.10. Method for Manufacturing Ink Jet Ink

A method for manufacturing the ink jet ink of this embodiment is not particularly limited, and for example, a method in which the pigment, the inorganic oxide colloid, the betaine, and water are mixed together with, if needed, other components may be mentioned. In addition, the inorganic oxide colloid may be mixed in a colloid solution state, or when the pigment is used, the inorganic oxide colloid may be mixed in the state of a pigment dispersion liquid.

In addition, in the method for manufacturing the ink jet ink of this embodiment, in the mixing or after the mixing, there may be provided a step of controlling the total concentration of potassium ions and sodium ions in the ink to 500 ppm or less by dialysis or the like.

### 2. Ink Jet Method

An ink jet method according to this embodiment includes an ejection step of ejecting the ink jet ink described above onto a recording medium using a predetermined ink jet head and a transport step of transporting the recording medium to which the ink is adhered. In addition, the ejection step and the transport step may be simultaneously or alternately performed.

### 2.1. Ejection Step

In the ejection step, the ink is ejected from the ink jet head and is adhered to the recording medium. In more particular, a pressure generation device provided in the ink jet head is driven to eject the ink filled in a pressure generation chamber of the ink jet head from a nozzle. The ejection method as described above is also called an ink jet method.

As the ink jet head used in the ejection step, a line head which performs recording by a line method and a serial head which performs recording by a serial method may be mentioned.

In the line method using a line head, for example, an ink jet head having a width equivalent to or larger than a recording width of the recording medium is fixed to a recording apparatus. In addition, the recording medium is transferred along a sub-scanning direction (transport direction of the recording medium), and in association with this transfer, ink droplets are ejected from nozzles of the ink jet head, so that an image is recorded on the recording medium.

In the serial method using a serial head, for example, the ink jet head is mounted on a carriage configured to be transferred in a width direction of the recording medium. In addition, the carriage is transferred along a main scanning direction (width direction of the recording medium), and in association with this transfer, ink droplets are ejected from nozzles of the ink jet head, so that an image is recorded on the recording medium.

### 2.2. Transport Step

In the transport step, the recording medium is transported in a predetermined direction in the recording apparatus. In more particular, by the use of a transport roller and/or a transport belt provided in the recording apparatus, the recording medium is transported from a paper supply portion to a paper discharge portion of the recording apparatus. During the transport step described above, the ink ejected from the ink jet head is adhered to the recording medium, so that a recorded matter is formed. The transport may be continuously or intermittently performed.

### 2.3. Recording Medium

Although the recording medium used in this embodiment is not particularly limited, for example, an absorptive or a non-absorptive recording medium may be mentioned. Among those mentioned above, an absorptive recording medium is liable to cause a problem, such as curling; hence, the present disclosure is useful since the clogging recovery property is excellent although the inorganic oxide colloid is used.

Although the absorptive recording medium is not particularly limited, for example, regular paper, such as electrophotographic paper, and ink jet paper (ink jet exclusive paper including an ink absorbing layer formed from silica particles or alumina particles or an ink absorbing layer formed from a hydrophilic polymer, such as a poly(vinyl alcohol) (PVA) or a poly(vinyl pyrrolidone) (PVP)) each having a high ink permeability may be mentioned, and in addition, for example, art paper, coated paper, and cast paper, which have a relatively low ink permeability and which are used for general offset printing, may also be mentioned.

Although the non-absorptive recording medium is not particularly limited, for example, as the recording medium, there may be mentioned a film or a plate of a plastic, such as a poly(vinyl chloride), a polyethylene, a polypropylene, a poly(ethylene terephthalate) (PET), a polycarbonate, a polystyrene, or a polyurethane; a plate of a metal, such as iron, silver, copper, or aluminum; a metal plate or a plastic film, each of which is manufactured by deposition of at least one metal mentioned above; a plate of an alloy, such as stainless steel or brass; or a paper-made base material to which a film of a plastic, such as a poly(vinyl chloride), a polyethylene, a polypropylene, a PET, a polycarbonate, a polystyrene, or a polyurethane, is adhered (coated).

### 3. Recording Apparatus

A recording apparatus of this embodiment includes an ink jet head having a nozzle which ejects an ink jet ink to a recording medium and a transport device which transports the recording medium. The ink jet head includes a pressure chamber to which the ink is supplied and the nozzle which ejects the ink. In addition, the transport device is formed of a transport roller and/or a transport belt provided in the recording apparatus.

Hereinafter, the recording apparatus according to this embodiment will be described with reference to FIGURE. In addition, in an X-Y-Z coordinate system shown in FIGURE, an X direction indicates a length direction of the recording medium, a Y direction indicates a width direction of the recording medium in a transport path in the recording apparatus, and a Z direction indicates an apparatus height direction.

As one example of a recording apparatus 10, a Line type ink jet printer capable of performing high-speed and high-density printing will be described. The recording apparatus 10 includes a supply portion 12 receiving a recording medium P, such as paper, a transport portion 14, a belt transport portion 16, a recording portion 18, an Fd (face-down) discharge portion 20 functioning as a “discharge portion”, an Fd (face-down) stage portion 22 functioning as a “stage portion”, a reverse path portion 24 functioning as a “reverse transport mechanism”, an Fu (face-up) discharge portion 26, and an Fu (face-up) stage portion 28.

The supply portion 12 is provided at a lower side of the recording apparatus 10. The supply portion 12 includes a supply tray 30 which receives the recording medium P and a supply roller 32 which supplies the recording medium P received in the supply tray 30 to a transport path 11.

The recording medium P received in the supply tray is supplied to the transport portion 14 along the transport path 11 by the supply roller 32. The transport portion 14 includes a transport drive roller 34 and a transport driven roller 36. The transport drive roller 34 is rotary driven by a drive source not shown. In the transport portion 14, the recording medium P is nipped between the transport drive roller 34 and the transport driven roller 36 and is then transported to the belt transport portion 16 located downstream in the transport path 11.

The belt transport portion 16 includes a first roller 38 located upstream in the transport path 11, a second roller 40 located downstream therein, an endless belt rotatably provided around the first roller 38 and the second roller 40, and a support body 44 which supports an upper-side region 42a of the endless belt 42 between the first roller 38 and the second roller 40.

The endless belt 42 is driven by the first roller 38 or the second roller 40 which is driven by a drive source not shown so as to be transferred from a +X direction to a −X direction in the upper-side region 42a. Hence, the recording medium P transported from the transport portion 14 is further transported downstream in the transport path 11 by the belt transport portion 16.

The recording portion 18 includes a line type ink jet head 48 and a head holder 46 which holds this ink jet head 48. In addition, the recording portion 18 may also be a serial type in which an ink jet head is provided on a carriage configured to be reciprocally transferred in a Y axis direction. The ink jet head 48 is disposed to face the upper-side region 42a of the endless belt 42 supported by the support body 44. When the recording medium P is transported in the upper-side region 42a of the endless belt 42, the ink jet head 48 ejects the ink to the recording medium P, so that recording is performed. While recording is performed, the recording medium P is transported downstream in the transport path 11 by the belt transport portion 16.

In addition, the “line type ink jet head” is a head in which a nozzle region formed in a direction to intersect a transport direction of the recording medium P is provided to cover the entire intersection direction of the recording medium P, and this head is used in an recording apparatus in which one of the head and the recording medium P is fixed, and the other is transferred to form an image. In addition, the nozzle region of the line head in the intersection direction may not be required to cover the entire intersection direction of every recording medium P which is to be used in the recording apparatus.

In addition, a first branch portion 50 is provided downstream in the transport path 11 of the belt transport portion 16. The first branch portion 50 is configured to switch between the transport path 11 which transports the recording medium P to the Fd discharge portion 20 or to the Fu discharge portion 26 and a reverse path 52 of the reverse path portion 24 which reverses a recording surface of the recording medium P and again transports the recording medium P to the recording portion 18. In addition, in the recording medium P which is transported to the reverse path by switching of the first branch portion 50, the recording surface is reversed in a transport step in the reverse path 52, and a surface opposite to the original recording surface is again transported to the recording portion 18 so as to face the ink jet head 48.

A second branch portion 54 is further provided downstream of the first branch portion 50 along the transport path 11. The second branch portion 54 is configured to switch a transport direction of the recording medium P so that the recording medium P is transported to the Fd discharge portion 20 or to the Fu discharge portion 26.

The recording medium P transported to the Fd discharge portion 20 by the second branch portion 54 is discharged from the Fd discharge portion 20 and is placed on the Fd stage portion 22. In this step, the recording surface of the recording medium P is placed so as to face the Fd stage portion 22. In addition, the recording medium P transported to the Fu discharge portion 26 by the second branch portion 54 is discharged from the Fu discharge portion 26 and is placed on the Fu stage portion 28. In this step, the recording surface of the recording medium P is placed so as to face a side opposite to the Fu stage portion 28.

In a recording apparatus using an ink jet method, since an ink which is a liquid is adhered to a recording medium, for example, a problem, such as curling, may occur in a recording medium, in particular, in an absorptive recording medium, such as regular paper or ink jet paper, and in addition, a problem in that since being discharged and stacked before the ink is dried, recorded matters cannot be accurately stacked to each other may also occur. In particular, when the recording medium is transported at a high speed of 0.5 m/s or more, the problems described above tend to be serious. In addition, in the case of a solid image having a high wet friction resistance on an ink jet printing surface, the recorded matters are not smoothly slid and are jammed to each other, or although being approximately stacked to each other, the recorded matters cannot be accurately aligned to each other; hence, a problem in that the recorded matters cannot be stapled at the accurate positions may occur in some cases. In addition, in a face-down paper discharge in which paper is discharged while a printing surface thereof faces downward, since the ink is difficult to dry, a problem in that a stacking property is difficult to obtain may arise in some cases. In addition, since a printing surface of an absorptive recording medium is swelled when printing is performed thereon, paper discharge curling (primary curling) in which the printing surface forms a convex shape right after the printing is also disadvantageously generated. Furthermore, when the drying is advanced, since the printing surface is contracted, permanent curling (secondary curling) in which the printing surface forms a concave shape within ten and several seconds to several minutes is disadvantageously generated.

On the other hand, in this embodiment, since the ink jet ink containing an inorganic oxide colloid is used, while the wet friction resistance of the printing surface is decreased, the curling can be suppressed, so that the stacking property can be improved. In particular, when ink jet recording is performed while the recording medium P is transported at a high speed of 0.5 m/s or more, an effect of improving the stacking property becomes significant.

In addition, although the case in which the line type ink jet head is used is described by way of example, the recording apparatus according to this embodiment may be a printer (serial printer) using a serial type ink jet head. In the serial printer, while a recording medium is transported in a transport direction, the ink jet head is transferred in a direction intersecting the transport direction to perform printing. Even by the serial printer, when a relative speed between the head and the recording medium during the printing is high, such as 0.5 m/s or more, a problem of the stacking property is generated; hence, by the use of the ink described above, the effect of improving the stacking property can be obtained.

### EXAMPLES

Hereinafter, the present disclosure will be described in more detail with reference to examples and comparative examples. However, the present disclosure is not limited to the following examples.

### 1. Preparation of Ink

After components were charged in a mixture tank so as to have a composition shown in Table 1 and were then mixed and stirred, filtration using a 5-μm membrane filter was performed, so that an ink jet ink of each example was obtained. In addition, unless otherwise particularly noted, the numerical value of each component shown in each example of the table represents percent by mass. In addition, in the table, the numerical values of an inorganic oxide colloid and a pigment dispersion liquid each represent percent by mass of a solid component.

TABLE 1

| | | | | | | | | | | | COMPARATIVE | | |
|---|---|---|---|---|---|---|---|---|---|---|---|---|---|
| | | EXAMPLE | | | | | | | | | EXAMPLE | | |
| | | 1 | 2 | 3 | 4 | 5 | 6 | 7 | 8 | 9 | 1 | 2 | 3 |
| PIGMENT | BLACK PIGMENT | 7.0 | | | | 7.0 | 7.0 | 7.0 | 7.0 | 7.0 | 7.0 | 7.0 | |
| DISPERSION | CAB-O-JET ® 300 | | | | | | | | | | | | |
| LIQUID | CYAN PIGMENT | | 5.0 | | | | | | | | | | 5.0 |
| | CAB-O-JET ® 250C | | | | | | | | | | | | |
| | MAGENTA PIGMENT | | | 8.0 | | | | | | | | | |
| | CAB-O-JET ® 260M | | | | | | | | | | | | |
| | YELLOW PIGMENT | | | | 7.0 | | | | | | | | |
| | CAB-O-JET ® 470Y | | | | | | | | | | | | |
| INORGANIC | ST-CM (PARTICLE | 7.0 | 7.0 | 7.0 | 7.0 | | 7.0 | 7.0 | 1.0 | 7.0 | 7.0 | | 7.0 |
| OXIDE | DIAMETER 20 nm) | | | | | | | | | | | | |
| COLLOID | ST-30L (PARTICLE | | | | | 9.0 | | | | | | | |
| | DIAMETER 45 nm) | | | | | | | | | | | | |
| RESIN | URETHANE RESIN | 1.0 | 1.0 | 1.0 | 1.0 | 1.0 | | 1.0 | 1.0 | 1.0 | 1.0 | 1.0 | 1.0 |
| EMULSION | EMULSION | | | | | | | | | | | | |
| | STYRENE-ACRYLIC | | | | | | 1.0 | | | | | | |
| | RESIN EMULSION | | | | | | | | | | | | |
| BETAINE | TRIMETHYL GLYCINE | 8.0 | 8.0 | 8.0 | 8.0 | 10.0 | 8.0 | 8.0 | 8.0 | 7.0 | 8.0 | 8.0 | |
| WATER- | 2-PYRROLIDONE | 5.0 | 5.0 | 5.0 | 5.0 | 5.0 | 5.0 | 5.0 | 5.0 | 5.0 | 5.0 | 5.0 | 5.0 |
| SOLUBLE | GLYCERIN | 3.5 | 5.5 | 2.5 | 3.5 | 3.5 | 4.5 | 6.9 | 5.5 | 5.5 | 3.8 | 10.5 | 12.0 |
| ORGANIC | TEGmBE | 2.0 | 2.0 | 2.0 | 2.0 | 2.0 | 2.0 | 2.0 | 2.0 | 2.0 | 2.0 | 2.0 | 2.0 |
| SOLVENT | | | | | | | | | | | | | |
| SURFACTANT | OLFINE E1010 | 0.5 | 0.5 | 0.5 | 0.5 | 0.5 | 0.5 | 0.5 | 0.5 | 0.5 | 0.5 | 0.5 | 0.5 |
| | SURFYNOL 104 | 0.5 | 0.5 | 0.5 | 0.5 | 0.5 | 0.5 | 0.5 | 0.5 | 0.5 | 0.5 | 0.5 | 0.5 |
| pH ADJUSTER | TRIISOPROPANOLAMINE | 0.5 | 0.5 | 0.5 | 0.5 | 0.5 | 0.5 | | 0.5 | 0.5 | | 0.5 | 0.5 |
| | POTASSIUM HYDROXIDE | | | | | | | 0.1 | | | 0.2 | | |
| WATER | PURIFIED WATER | 65.0 | 65.0 | 65.0 | 65.0 | 61.0 | 64.0 | 62.0 | 69.0 | 64.0 | 65.0 | 65.0 | 66.5 |
| ION | TOTAL CONCENTRATION OF | 300 | 250 | 330 | 310 | 450 | 250 | 500 | 200 | 200 | 700 | 130 | 80 |
| CONCENTRATION | Na IONS AND K IONS (ppm) | | | | | | | | | | | | |
| RESULT | COLOR DEVELOPMENT | A | A | A | A | A | A | A | B | A | A | D | D |
| | CLOGGING RECOVERY | A | A | A | A | B | A | B | A | B | D | A | C |
| | PROPERTY | | | | | | | | | | | | |

Abbreviations and product components used in Table 1 are as follows.
PIGMENT DISPERSION LIQUID
Black pigment (CAB-O-JET300 (manufactured by Cabot Corporation), solid content: 15%)
Cyan pigment (CAB-O-JET250C (manufactured by Cabot Corporation), solid content: 10%)
Magenta pigment (CAB-O-JET260M (manufactured by Cabot Corporation), solid content: 10%)
Yellow pigment (CAB-O-JET470Y (manufactured by Cabot Corporation), solid content: 15%)
INORGANIC OXIDE COLLOID
Colloidal silica (manufactured by Nissan Chemical Corporation, ST-CM, particle diameter: 20 nm, solid content: 30%)
Colloidal silica (manufactured by Nissan Chemical Corporation, ST-30L, particle diameter: 45 nm, solid content: 30%)
RESIN EMULSION
Urethane resin emulsion (manufactured by DKS Co., Ltd., Superflex 420, Tg: −10° C.)
Styrene-acrylic resin emulsion (manufactured by Seiko PMC Corporation, X-436, Tg: 33° C., acid value: 33 mgKOH/g)
BETAINE
Trimethyl glycine (betaine anhydrous, manufactured by Tokyo Chemical Industry Co., Ltd.)
WATER-SOLUBLE ORGANIC SOLVENT
2-pyrrolidone
Glycerin
Triethylene glycol monobutyl ether (TEGmBE)
SURFACTANT
Olfine E1010 (trade name, manufactured by Air Products & Chemicals Inc., acetylene glycol surfactant)
Surfynol 104 (trade name, manufactured by Nisshin Chemical Industry Co., Ltd., acetylene glycol surfactant)
pH ADJUSTER
Triisopropanolamine (manufactured by Tokyo Chemical Industry Co., Ltd.)
Potassium hydroxide

### 1.1 ION CONCENTRATION

In Table 1, the concentration of sodium ions was measured by a compact potassium ion meter LAQUAtwin <K-11> (manufactured by HORIBA, Ltd.), and the concentration of potassium ions was measured by a compact potassium ion meter LAQUAtwin <Na-11> (manufactured by HORIBA, Ltd.). In addition, a measurement temperature was set to 25° C. A total concentration (mg/L) thus obtained was shown by ppm in Table 1.

In addition, when the concentration of calcium ions was measured by a compact calcium ion meter LAQUAtwin (manufactured by HORIBA, Ltd.), the concentration of the ink of each example was 20 ppm or less.

### 2. Evaluation Method

### 2.1. Color Developing Property

The ink was filled in an ink cartridge of a PX-S840 (serial ink jet printer) manufactured by EPSON. Subsequently, a solid pattern having a duty of 100% was printed in an environment at a temperature of 25° C. and a humidity of 50% on Xerox P paper (A4-size copy paper manufactured by Fuji Xerox Co., Ltd., basis weight: 64 g/m², paper thickness: 88 μm). In addition, an ink adhesion amount was set to 4.5 mg/inch². Subsequently, an OD value was measured using a colorimeter (manufactured by Xrite, Xrite i1), and the color developing property was evaluated in accordance with the following evaluation criteria. The results are shown in Table 1.

Evaluation Criteria

A: OD value of 1.3 or more

B: OD value of less than 1.3 to 1.2

C: OD value of less than 1.2 to 1.1

D: OD value of less than 1.1

### 2.2. Evaluation of Clogging Recovery Property

The ink was filled in an ink cartridge of a PX-5840 (serial ink jet printer) manufactured by EPSON, and all nozzles were confirmed to eject the ink. Subsequently, in the state in which an ink jet head was shifted from a position of a cap provided in the printer and was not capped, the ink jet head was left for 7 days in an environment at a temperature of 40° C. and a humidity of 20%.

After the ink jet head was left as described above, as cleaning of the ink jet head, a suction operation of the ink in the nozzle was performed. After each suction operation, the number of nozzles which were not able to eject the ink was counted, and the cleaning operation was repeatedly performed until all the nozzles were recovered. In addition, based on the number of cleaning operations at which all the nozzles were recovered, the clogging recovery property was evaluated in accordance with the following criteria. The results are shown in Table 1.

Evaluation Criteria

A: The number of cleaning operations is less than 3 times.

B: The number of cleaning operations is 3 to less than 6 times.

C: The number of cleaning operations is 6 to less than 9 times.

D: The number of cleaning operations is 9 times or more.

### 3. Evaluation Result

In Table 1, the composition of the ink used in each example and the evaluation results thereof are shown. From Table 1, it is found that when an ink which contains a betaine and which has a total concentration of potassium ions and sodium ions in the ink of 500 ppm or less is used, even if this ink contains an inorganic oxide colloid, an excellent clogging recovery property can be obtained.

In particular, when each example is compared to Comparative Example 1, it is found that since the total concentration of potassium ions and sodium ions in the ink is lower than 500 ppm, the clogging recovery property is excellent. Furthermore, when each example is compared to Comparative Example 2, it is found that since the inorganic oxide colloid is contained, the color development is improved. In addition, when each example is compared to Comparative Example 3, it is found that since the betaine is contained, the color development is improved.

In addition, after the ink of each example was filled in an ink cartridge of an LX-10000F (line ink jet printer) manufactured by EPSON, when a solid pattern having a duty of 100% was continuously printed in an environment at a temperature of 25° C. and a humidity of 50% on 20 recording media (A4-size Xerox P paper, copy paper manufactured by Fuji Xerox Co., Ltd., basis weight: 64 g/m², paper thickness: 88 μm), and the recording media were discharged so as to face downward, the recording media were preferably stacked to each other.

What is claimed is:

1. An ink jet ink containing:
a pigment;
an inorganic oxide colloid;
a betaine; and
water,
wherein a total concentration (mg/L) of potassium ions and sodium ions in the ink is 500 ppm or less.

2. The ink jet ink according to claim 1,
further comprising a resin emulsion.

3. The ink jet ink according to claim 1,
wherein the inorganic oxide colloid includes a colloidal silica.

4. The ink jet ink according to claim 1,
wherein a content of the inorganic oxide colloid as a solid component is 1.0 to 10 percent by mass with respect to a total mass of the ink.

5. The ink jet ink according to claim 1,
wherein the betaine includes trimethyl glycine.

6. The ink jet ink according to claim 1,
wherein a content of the betaine is larger than a content of a solid component of the inorganic oxide colloid on a mass basis.

7. The ink jet ink according to claim 1,
wherein a content of the water with respect to a total mass of the ink is 50 to 80 percent by mass.

8. A recording apparatus comprising:
an ink jet head having a nozzle which ejects the ink jet ink according to claim 1 to a recording medium; and
a transport device which transports the recording medium.

9. The recording apparatus according to claim 8,
wherein the ink jet head includes a line head.
